(19) United States
(12) Patent Application Publication
(10) Pub. No.: US 2010/0013752 A1
(43) Pub. Date: Jan. 21, 2010

(54) Low Feed-Through Voltage Liquid Crystal Display Device And Related Operating Method

(76) Inventor: Li-Wei Sung, Tainan (TW)

Correspondence Address: TROP, PRUNER & HU, P.C., 1616 S. VOSS ROAD, SUITE 750, HOUSTON, TX, 77057-2631, US

(21) Appl. No.: 12/485,294

(22) Filed: Jun. 16, 2009

(30) Foreign Application Priority Data
Jul. 21, 2008 (TW) 97127712

(51) Int. Cl. G09G 3/36; G02F 1/133; G02F 1/1343

(52) U.S. Cl. 345/96; 349/33; 349/139; 349/37

(57) ABSTRACT

A liquid crystal display (LCD) device may include a scan line that is parallel and adjacent to a compensation signal line. A compensation signal transmitted on the compensation signal line may be the inverse of a scan signal transmitted on a scan line. Consequently, feed-through voltage may be reduced and gray levels may be more properly displayed in pixels.

### CROSS-REFERENCE TO RELATED APPLICATIONS

Pursuant to 35 U.S.C. §119, this application claims priority to Taiwan Application Serial No. 97127712, filed Jul. 21, 2008, the subject matter of which is incorporated herein by reference.

### BACKGROUND

To drive an active matrix liquid crystal display (AMLCD) device, a scan signal may be transmitted from a scan driver to a scan line and then to a switching device, such as a transistor, included in a pixel. The scan signal may enable and disable the transistor to drive the pixel. Specifically, the scan signal may enable the transistor when the scan signal is at a high level. The enabled transistor may then allow a data signal from a data line to charge a liquid crystal (LC) capacitor included in the pixel. This process adjusts the pixel voltage according to the data signal and consequently drives the pixel to display a corresponding gray level. The scan signal may then disable the transistor by driving the switch at a low level. The LC capacitor may then stop charging and hold its stored charge while the corresponding pixel displays its gray level. When the scan signal level changes (e.g., transitions from high level to low level), however, a feed-through voltage may be generated. The feed-through voltage may cause the pixel voltage to deviate from the intended level and the LC capacitor may consequently display an incorrect gray level.

### BRIEF DESCRIPTION OF THE DRAWINGS

FIG. 1 is a schematic illustration of a liquid crystal display (LCD) device according to an embodiment of the invention.

FIG. 2 is an equivalent circuit illustration, of an LCD device according to an embodiment of the invention.

FIG. 3A is a timing diagram for an LCD device according to an embodiment of the invention.

FIG. 3B is a timing diagram for an LCD device according to an embodiment of the invention.

FIG. 4 is a partial circuit layout for a portion of an LCD panel according to an embodiment of the invention.

FIG. 5 is a partial circuit layout for a portion of an LCD panel according to another embodiment of the invention.

### DETAILED DESCRIPTION

The following description refers to the accompanying drawings. Among the various drawings the same reference numbers may be used to identify the same or similar elements. While the following description provides a thorough understanding of various aspects of the claimed invention by setting forth specific details such as particular structures, architectures, interfaces, and techniques, such details are provided for purposes of explanation and should not be viewed as limiting. Moreover, those of skill in the art will, in light of the present disclosure, appreciate that various aspects of the invention claimed may be practiced in other examples or implementations that depart from these specific details. At certain junctures in the following disclosure descriptions, well known devices, circuits, and methods have been omitted to avoid clouding the description of various embodiments of the invention with unnecessary detail.

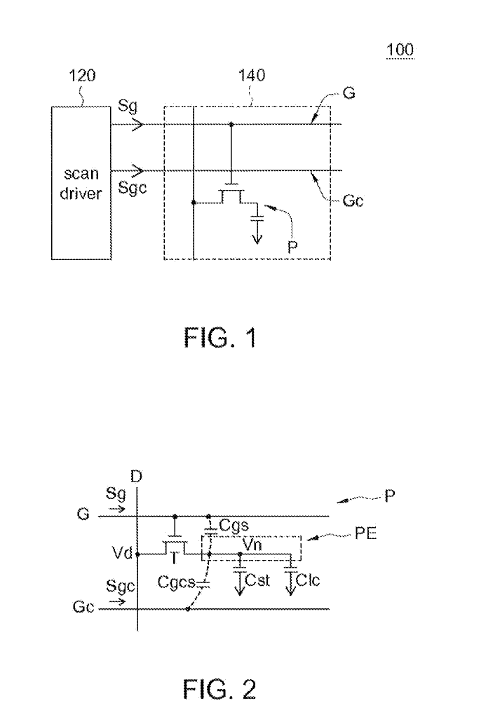

FIG. 1 is a schematic illustration of an LCD device according to an embodiment of the invention. LCD device 100 includes scan driver 120 arid LCD panel 140, which may be an AMLCD panel or other form of LCD panel. Scan driver 120 may output scan signal Sg and compensation signal Sgc. Scan driver 120 may be embodied in one or more circuits such as a circuit for outputting scan signal Sg and another circuit for outputting compensation signal Sgc. Compensation signal Sgc may be, for example, an inverse of scan signal Sg. For example, if Sg is +4V then Sgc may be a polar inverse −4V and if Sg is −4V then Sgc may be +4V. As another example, if Sg is +4V then Sgc may be +2V and if Sg is +2V then Sgc may invert to +4V. LCD panel 140 may include pixel unit P, scan line G, and compensation signal line GC. Scan line G may be controlled by scan signal Sg to enable pixel unit P. Compensation signal line GC may transmit compensation signal Sgc to counter, reduce or eliminate feed-through voltage generated partially or fully by, for example, scan signal Sg.

FIG. 2 is an equivalent circuit illustration of an LCD device according to an embodiment of the invention. Pixel unit P may include an active element, such as transistor T, as well as LC capacitor Clc, and storage capacitor Cst. Transistor T may be, for example, a negative-type (N-type) thin film transistor (TFT) or a positive-type (P-type) TFT. Transistor T may couple (e.g., electrically connect) data line D to LC capacitor Clc and storage capacitor Cst. A high level scan signal Sg, transmitted via scan line G, may enable transistor T. Enabled transistor T may apply data voltage Vd on data line D to LC capacitor Clc and storage capacitor Cst. LC capacitor Clc and storage capacitor Cst may be charged according to data voltage Vd to generate a corresponding pixel voltage Vn on pixel electrode PE. Pixel voltage Vn, however, may be influenced by parasitic capacitor Cgs located between scan line G and pixel electrode PE. Specifically, when scan signal Sg changes levels (e.g., from high level to low level), scan signal Sg may generate a feed-through voltage, due to parasitic capacitor Cgs, which may influence the magnitude of pixel voltage Vn.

However, in one embodiment of the invention compensation signal line GC may be generally adjacent and/or generally parallel to scan line G. Thus, pixel voltage Vn may also be influenced by parasitic capacitor Cgcs located, in one embodiment of the invention, between compensation signal line GC and pixel electrode PE. When scan signal Sg changes levels, compensation signal Sgc level may also change. Accordingly, compensation signal Sgc may influence pixel electrode PE via parasitic capacitor Cgcs. In other words, in one embodiment of the invention when scan signal Sg drives pixel unit P, compensation signal Sgc may be transmitted by scan driver 120 to reduce feed-through voltage generated by scan signal Sg.

As a brief aside, “parallel” is not intended to mean that every portion of scan line G must be precisely parallel to every portion of compensation signal line GC. Also, “adjacent” means that compensation signal line GC is located close enough to scan line G to have a material operative effect upon any parasitic capacitance generated by, for example, compensation signal Sg. Adjacent lines are not necessarily located on the same plane or layer.

Still regarding FIG. 2, feed-through voltage Vp′ may be expressed as:

$${Vp}^{′} = \frac{Cgs \cdot Δ Vg}{Ctotal} \qquad Eq . ( 1 )$$

where Cgs is the capacitance of parasitic capacitor Cgs, ΔVg is the change in voltage level of scan signal Sg, Cgs·ΔVg is the stored charge applied to pixel electrode PE, and Ctotal is the equivalent capacitance with respect to pixel electrode PE. Ctotal may be the sum of the capacitances of parasitic capacitor Cgs, LC capacitor Clc, and storage capacitor Cst.

In one embodiment of the invention, however, compensation signal line Gc is used and, accordingly, feed-through voltage Vp is expressed as:

$$Vp = \frac{Cgs \cdot Δ Vg + Cgcs \cdot Δ Vgc}{Ctotal} \qquad Eq . ( 2 )$$

where similar notations from Eq. (1) are used. Furthermore, Cgcs is the capacitance of parasitic capacitor Cgcs, ΔVgc is the change in voltage level of compensation signal Sgc, Cgs·ΔVg+Cgcs·ΔVgc is the stored charge applied to pixel electrode PE, and Ctotal is the sum of the capacitances of parasitic capacitors Cgs and Cgcs, LC capacitor Clc, and storage capacitor Cst.

Accordingly, lowering the stored charges (e.g., Cgs·ΔVg+Cgcs·ΔVgc) may lower or eliminate feed-through voltage Vp. In one embodiment of the invention, compensation signal Sgc may be a polar inverse signal of scan signal Sg. Thus, the polarity of voltage level change ΔVgc of compensation signal Sgc may be opposite to the polarity of voltage level change ΔVg of scan signal Sg. Consequently, the value of the stored charges (Cgs·ΔVg+Cgcs·ΔVgc) may be reduced along with any related feed-through voltage.

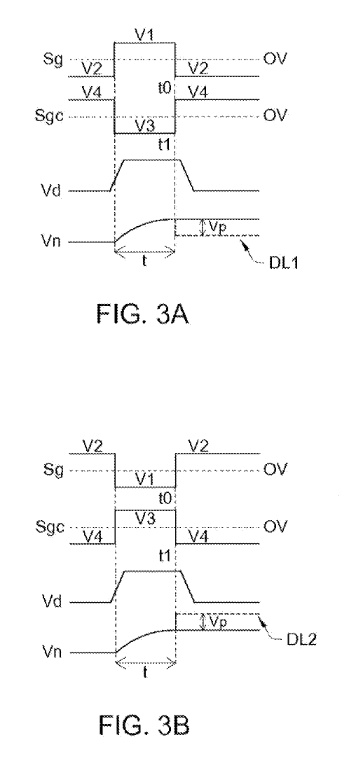

FIG. 3A is a timing diagram for the LCD device of FIG. 2 according to an embodiment of the invention where transistor T is an N-type TFT. Scan signal Sg may lower from first voltage V1 to second voltage V2. Thus, feed-through voltage Vp, which may be generated when scan signal Sg disables the N-type TFT, may pull down pixel voltage Vn as depicted by dashed line DL1. However, compensation signal Sgc may rise from third voltage V3 to fourth voltage V4 to counter scan signal Sg activity. Time point t0 may be where scan signal Sg lowers from first voltage V1 to second voltage V2 and time point t1 may be where of the invention, t0 and t1 are at the same point in time. During time period t, if scan signal Sg has a high level first voltage V1 then compensation signal Sgc may have a low level third voltage V3. At time point t0, if scan signal Sg converts to a low level second voltage V2 then scan signal Sg may convert to a high level fourth voltage V4.

Because first voltage V1 is higher than second voltage V2 (V1>V2), voltage level change ΔVg of compensation signal Sgc is positive (ΔVg=V1−V2>0). Also, because fourth voltage V4 is higher than third voltage V3 (V4>V3), voltage level change ΔVgc of compensation signal Sgc is negative (ΔVgc=V3−V4<0). Furthermore, because the polarity of ΔVg is opposite to the polarity of ΔVgc, the value of the stored charges (Cgs·ΔVg+Cgcs·ΔVgc) may be decreased. Thus, feed-through voltage Vp (depicted as the difference between Vn and DL1) may be reduced, substantially eliminated, or eliminated entirely as feed-through voltage Vp approaches or reaches 0V.

FIG. 3B is a timing diagram for tire LCD device of FIG. 2 according to an embodiment of the invention where transistor T is a P-type TFT. Because a P-type TFT is used, the voltage of scan signal Sg used to enable the P-type TFT may be smaller than the voltage used to disable the P-type TFT. Thus, first voltage V1 of scan signal Sg may be smaller than second voltage V2. Feed-through voltage Vp, which may be generated when scan signal Sg disables the P-type TFT, may pull up pixel voltage Vn as depicted by dotted line DL2. Fourth voltage V4 of compensation signal Sgc may be smaller than third voltage V3. At time point t0, when scan signal Sg may disable the P-type TFT, the compensation signal Sgc level may change in the opposite direction of the scan signal Sg level change. Accordingly, the polarity of ΔVg may be opposite to the polarity of ΔVgc and the value of stored charges (Cgs·ΔVg+Cgcs·ΔVgc) and feed-through voltage Vp may be reduced or eliminated.

Time points t0 and t1 may be generally or substantially the same. However, in other embodiments time points t0 and t1 may be different. For example, in one embodiment of the invention the difference between time point t0 (when Sg converts from V1 to V2) and time point t1 (when Sgc converts from V3 to V4) may be less than 0.5 microseconds. In other words, taking FIG. 3A as an example, V1 and V3 may be applied simultaneously. In such a scenario, V1 and V3 may be initially applied (i.e., as indicated by the respective rising edge for V1 and the falling edge for V3) at the exact same time. However, V1 and V3 may be simultaneously applied while still being initially applied at different times. Furthermore, V1 and V3 may be applied simultaneously regardless of whether V1 and V3 are discontinued at the same exact time or at differing times. For example, V1 and V3 may be said to be simultaneously applied when V1 and V3 are initially applied at differing times but discontinued at the exact or nearly exact times. Specifically, V3 may be initially applied after V1 is initially applied while V1 and V3 are discontinued within, for example, 0.5 microseconds of one another. As still another example, V1 and V3 may be said to be simultaneously applied when V1 and V3 are initially applied at differing times and discontinued at differing times. As still another example, V1 and V3 may be said to be simultaneously applied when V1 and V3 are initially applied at the same or nearly the same times and discontinued at the same or nearly the same times. As still another example, V1 and V3 may be said to be simultaneously applied when V1 and V3 are initially applied at differing times and discontinued at differing times. As seen from the above, embodiments of the invention may use different initial application time and discontinuation time combinations of V1 and V3. Accordingly, “simultaneously” in this example means that there is some overlapping time when V1 and V3 are applied.

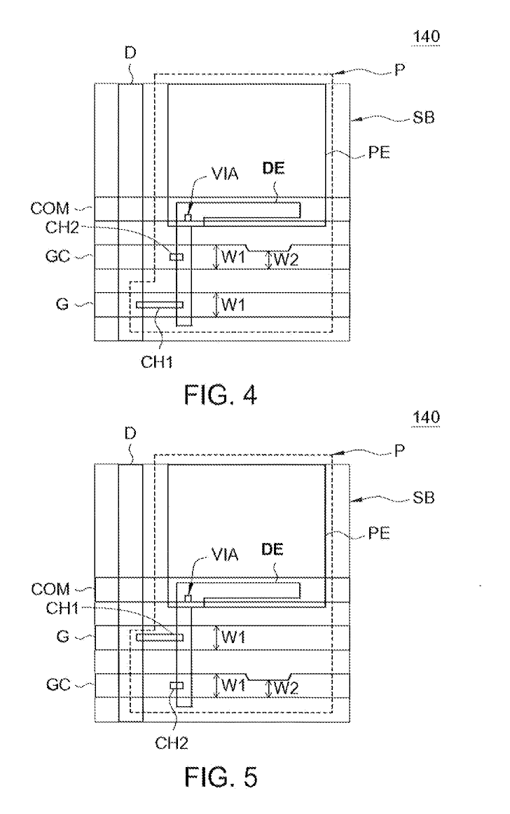

FIG. 4 is a partial circuit layout for a portion of an LCD panel according to an embodiment of the invention. LCD panel 140 may include pixel unit P, pixel electrode PE, drain electrode DE, common electrode trace COM, compensation signal line GC, scan line G, first channel layer CH1, second channel layer CH2, and data line D. Drain electrode DE may be an electrode coupled to transistor T and pixel electrode PE of FIG. 1. The electrode is a drain electrode DE in one embodiment of the invention but may be, for example, a source electrode in other embodiments. Drain electrode DE may be coupled (e.g., electrically connected) to pixel electrode PE through, for example, via hole V1A. First channel layer CH1 may be coupled to scan line G. Second channel layer CH2 may be coupled to compensation signal line GC. Data line D may be coupled to drain electrode DE via first channel layer CH1. However, in one embodiment of the invention data line D may be unable to communicate a data signal to drain electrode DE via second channel layer CH2. Specifically, CH2 may be associated with a “dummy” transistor that is formed not to communicate data from data line D to drain electrode DE but to instead simulate certain desired capacitance effects as described above. For example, in one embodiment dummy TFT is never turned on by the compensation signal line GC and thus data line D does not communicate a data signal to drain electrode DE via second channel layer CH2. As another example, dummy TFT may connect to drain electrode DE but may not connect to data line D in a fashion that would allow data line D to effectively communicate a data signal to drain electrode DE via second channel layer CH2.

In an embodiment of the invention, common electrode trace COM may partly overlap pixel electrode PE. In other words, a vertical axis may intersect both common electrode trace COM and pixel electrode PE even though common electrode trace COM does not directly contact pixel electrode PE. Scan line G may not overlap pixel electrode PE but may partly overlap drain electrode DE. Compensation signal line GC may not overlap pixel electrode PE but may partly overlap drain electrode DE. First channel layer CH1 may partly overlap drain electrode DE and data line D. Second channel layer CH2 may partly overlap drain electrode DE but may not overlap data line D.

In embodiments where first channel layer CH1 couples to scan line G and partly overlaps drain electrode DE, which may in turn couple to pixel electrode PE, a parasitic capacitor or capacitance may exist between scan line G and pixel electrode PE (e.g., parasitic capacitor Cgs shown in FIG. 2). Similarly, in embodiments where second channel layer CH2 couples to compensation signal line GC and partly overlaps drain electrode DE, a parasitic capacitor or capacitance may exist between compensation signal line GC and pixel electrode PE (e.g., parasitic capacitor Cgcs shown in FIG. 2). As explained above, feed-through voltage based on capacitance Cgs may be reduced by transmitting different signals on the compensation signal line GC and scan line G.

In one embodiment of the invention, first channel layer CH1, unlike second channel layer CH2, may partly overlap data line D and may have more parasitic capacitance than channel layer CH2. To compensate for this characteristic, in some embodiments of the invention the equivalent resistance of scan line G may be designed to be different (e.g., larger) than the equivalent resistance of compensation signal line GC. For example, the width of a part of compensation signal line GC may be smaller than a width of scan line G. Thus, to make parasitic capacitor Cgcs equivalent or nearly equivalent to parasitic capacitor Cgs, the equivalent resistance of the scan line may be designed to be different (e.g., larger) than the equivalent resistance of the compensation signal line. As shown in FIG. 4, the width of a part of scan line G is W1 and the width of a part of compensation signal line GC is W2, where W2<W1.

Also, in a further attempt to make parasitic capacitor Cgcs equivalent or nearly equivalent to parasitic capacitor Cgs in one embodiment of the invention, the characteristics of second channel layer CH2 may be designed to be similar to those of first channel layer CH1. For example, the scan line and the compensation signal line may be formed from the same photo process. Also, the materials of the scan line and the compensation signal line may be substantially the same. However, the materials of scan line G and compensation signal line GC can also be purposely designed to be different from each other so the equivalent resistance of scan line G is different (e.g., larger) than the equivalent resistance of compensation signal line GC.

FIG. 5 is a partial circuit layout for a portion of an LCD panel according to an embodiment of the invention, which shows scan line G may be located between common electrode trace COM and compensation signal line GC.

Thus, according to various embodiments of the invention, a compensation signal line may be adjacent and parallel to a scan line. Also, a compensation signal transmitted on the compensation signal line may be the inverse of a scan signal transmitted on the scan line. Consequently, such embodiments may eliminate or reduce feed-through voltage and more properly display gray levels in pixels.

While a limited number of embodiments of the invention have been described, those skilled in the art will appreciate numerous modifications and variations therefrom. It is intended to cover various modifications and similar arrangements and procedures, and the scope of the appended claims therefore should be accorded the broadest interpretation so as to encompass all such modifications and similar arrangements and procedures.

What is claimed is:

1. A method for operating a liquid crystal display (LCD) device comprising:
during a first time period, applying (a) a first scan voltage to a scan line, (b) a first compensation voltage to a compensation line located adjacent to the scan line, and (c) a data signal to a pixel electrode included in the LCD; and
during a second time period, applying (a) a second scan voltage to the scan line to generate a feed-through voltage, and (b) a second compensation voltage to the compensation line to counter the feed-through voltage.

2. The method of claim 1, further comprising applying the first scan voltage and the first compensation voltage simultaneously.

3. The method of claim 2, further comprising initially applying the second scan voltage and the second compensation voltage at the same general time.

4. The method of claim 2, wherein an absolute difference between the first and second scan voltages is generally equal to an absolute difference between the first and second compensation voltages.

5. The method of claim 2, wherein the first scan voltage is a polar inverse of the first compensation voltage.

6. The method of claim 2, further comprising initially applying the first scan voltage and the first compensation voltage at the same general time.

7. The method of claim 2, further comprising initially applying the second scan voltage within 0.5 microseconds of initially applying the second compensation voltage.

8. The method of claim 1, further comprising initially applying the first scan voltage and the first compensation voltage at differing times and initially applying the second scan voltage within 0.5 microseconds of initially applying the second compensation voltage.

9. A liquid crystal display (LCD) device, comprising:
a pixel that includes a switch and a pixel electrode; and
a scan line and a compensation line to capacitively couple to the pixel;
wherein (a) during a first time period, a first scan voltage is to be applied to the scan line simultaneously with a first compensation voltage being applied to the compensation line and a data signal being applied from a data line to the pixel electrode, and, (b) during a second time period, a second scan voltage is to be applied to the scan line simultaneously with a second compensation voltage being applied to the compensation line.

10. The device of claim 9, wherein the scan line includes a first equivalent resistance and the compensation line includes a second equivalent resistance that is less than the first equivalent resistance.

11. The device of claim 10, wherein a minimum width of the scan line is greater than a minimum width of the compensation line.

12. The device of claim 9, wherein the scan line is generally adjacent to the compensation line.

13. The device of claim 12, wherein the scan line is generally parallel to the compensation line.

14. The device of claim 13, wherein the compensation line is between the pixel electrode and the scan line.

15. The device of claim 13, wherein the scan and compensation lines are each formed from the same photo process.

16. The device of claim 9, wherein the pixel includes an additional switch and the switch and the additional switch each connect to an electrode that couples to the pixel electrode.

17. The device of claim 13, wherein the scan and compensation lines do not overlap the pixel electrode.

18. The device of claim 13, further comprising:
an electrode to couple the data line, through a first channel layer, to the pixel electrode to communicate the data signal from the data line to the pixel electrode;
wherein the electrode and the scan line overlap, the electrode and the compensation line overlap, and the first channel layer and the scan line overlap.

19. A liquid crystal display (LCD) device, comprising:
a scan line, a compensation line, and a scan driver to simultaneously apply, during a first time period, a first scan voltage to the scan line and a first compensation voltage to the compensation line, and, during a second time period, a second scan voltage to the scan line and a second compensation voltage to the compensation line; and
a data driver to apply, during the first time period, a data signal to a pixel electrode included in the pixel;
wherein the first scan voltage is a polar inverse of the first compensation voltage.

20. The device of claim 19, wherein the scan line includes a first equivalent resistance and the compensation line includes a second equivalent resistance that is less than the first equivalent resistance.

21. The device of claim 20, wherein a minimum width of the scan line is greater than a minimum width of the compensation line.

22. The device of claim 19, wherein the scan line is generally adjacent and parallel to the compensation line.

23. The device of claim 22, wherein the device is to generate a first capacitance between the scan line and the pixel electrode and a second capacitance between the compensation line and the pixel electrode; the second capacitance to reduce feed-through voltage induced by the first capacitance.
